(19) United States
(12) Patent Application Publication
(10) Pub. No.: US 2016/0337884 A1
(43) Pub. Date: Nov. 17, 2016

(54) Method for Transmitting Absolute Grant Value and User Equipment

(71) Applicant: Huawei Technologies Co., Ltd., Shenzhen (CN)

(72) Inventors: Shurong Jiao, Shanghai (CN); Meng Hua, Shanghai (CN); Yueying Zhao, Shanghai (CN); Xiaolei Tie, Shanghai (CN); Wenquan Hu, Shanghai (CN); Fan Wang, Kista (SE)

(21) Appl. No.: 15/223,349

(22) Filed: Jul. 29, 2016

Related U.S. Application Data
(63) Continuation of application No. PCT/CN2015/071470, filed on Jan. 23, 2015.

(30) Foreign Application Priority Data
Jan. 29, 2014 (CN) 201410043923.5
Apr. 1, 2014 (CN) 201410130001.8
May 8, 2014 (CN) 201410193799.0
May 16, 2014 (CN) 201410208807.4

(51) Int. Cl. H04W 24/02; H04W 72/04; H04W 72/14

(52) U.S. Cl. CPC H04W 24/02; H04W 72/14; H04W 72/042; H04W 88/02

(57) ABSTRACT

A method for transmitting an absolute grant (AG) value and a user equipment, where the method includes receiving, by a user equipment, a conventional enhanced-absolute grant channel (E-AGCH) and a newly-added grant value detecting E-AGCH that are sent by a network side device, detecting, by the user equipment, AG information carried on at least one channel of the conventional E-AGCH and the newly-added grant value detecting E-AGCH, and controlling data transmission of the user equipment according to a detection result. Hence, continuity of the data transmission of the user equipment may be ensured, and transmission efficiency is improved.

### CROSS-REFERENCE TO RELATED APPLICATIONS

This application is a continuation of international patent application number PCT/CN2015/071470 filed on Jan. 23, 2015, which claims priority to Chinese patent application number 201410043923.5 filed on Jan. 29, 2014, Chinese patent application number 201410130001.8 filed on Apr. 1, 2014, Chinese patent application number 201410193799.0 filed on May 8, 2014, and Chinese patent application number 201410208807.4 filed on May 16, 2014, all of which are incorporated by reference.

### TECHNICAL FIELD

The present disclosure relates to the field of communications technologies and, in particular, to a method for transmitting an absolute grant (AG) value and a user equipment (UE).

### BACKGROUND

In a conventional wideband code division multiple access (WCDMA) system, a network side device delivers a scheduling grant value to achieve an objective of scheduling uplink transmit power of a user, and a physical meaning of the scheduling grant value is an enhanced-dedicated physical data channel (E-DPDCH) to dedicated physical control channel (DPCCH) transmit power offset. The scheduling grant value may be classified into two types: an AG value and a relative grant (RG) value, where an enhanced-absolute grant channel (E-AGCH) is used to carry the AG value, and an enhanced-relative grant channel is used to carry the RG value.

In the prior art, a network side device may deliver an AG of a UE on a conventional E-AGCH or a new E-AGCH at a moment. Each UE simultaneously listens on the foregoing two channels. The UE sends data to the network side device according to the AG on the channel when detecting an AG that belongs to the UE itself on the conventional E-AGCH or the new E-AGCH, and the UE stops data transmission that is performed currently when detecting an AG of another UE on the new E-AGCH.

However, in the prior art, the network side device stops transmission of all UEs after sending an AG to a UE1 through the new E-AGCH, and then starts data transmission by sending an AG to another UE2 at a next moment, which may cause data transmission interruption of the UE2.

### SUMMARY

The present disclosure provides a method for transmitting an AG value and a UE, which are used to solve a problem in the prior art that data transmission interruption of a UE2 may be caused because a network side device stops transmission of all UEs after sending an AG to a UE1 through a new E-AGCH and then starts data transmission by sending an AG to another UE2 at a next moment.

A first aspect of the present disclosure provides a method for transmitting an AG value, including receiving, by a UE, a conventional E-AGCH and a newly-added grant value detecting E-AGCH that are sent by a network side device, and detecting, by the UE, AG information carried on at least one channel of the conventional E-AGCH and the grant value detecting E-AGCH, and controlling data transmission of the UE according to a detection result.

In a first possible implementation manner, according to the first aspect, detecting, by the UE, AG information carried on at least one channel of the conventional E-AGCH and the grant value detecting E-AGCH, and controlling current data transmission of the UE according to a detection result includes controlling, by the UE, the data transmission according to the first AG information of the UE if the UE detects that the at least one channel of the conventional E-AGCH and the grant value detecting E-AGCH carries first AG information of the UE.

In a second possible implementation manner, according to the first possible implementation manner, if the UE detects that the at least one channel of the conventional E-AGCH and the grant value detecting E-AGCH carries first AG information of the UE, controlling, by the UE, the data transmission according to the first AG information of the UE includes controlling, by the UE, the data transmission according to the first AG information of the UE if the UE detects that the conventional E-AGCH carries the first AG information of the UE, and controlling, by the UE, the data transmission according to the first AG information if the UE detects that the conventional E-AGCH does not carry the first AG information of the UE, and detects that the grant value detecting E-AGCH carries the first AG information of the UE.

In a third possible implementation manner, according to the first aspect, detecting, by the UE, AG information carried on at least one channel of the conventional E-AGCH and the grant value detecting E-AGCH, and controlling current data transmission of the UE according to a detection result includes skipping performing, by the UE, the data transmission if the UE detects that the conventional E-AGCH does not carry the first AG information of the UE and that the grant value detecting E-AGCH carries second AG information of another UE except the UE.

A second aspect of the present disclosure provides a UE, including a receiving module configured to receive a conventional E-AGCH and a newly-added grant value detecting E-AGCH that are sent by a network side device, and a detecting module configured to detect AG information carried on at least one channel of the conventional E-AGCH and the grant value detecting E-AGCH, and control data transmission of the UE according to a detection result.

In a first possible implementation manner, according to the second aspect, the detecting module is further configured to control the data transmission according to the first AG information of the UE if it is detected that the at least one channel of the conventional E-AGCH and the grant value detecting E-AGCH carries first AG information of the UE.

In a second possible implementation manner, according to the first possible implementation manner, the detecting module is further configured to control the data transmission according to the first AG information of the UE if it is detected that the conventional E-AGCH carries the first AG information of the UE, and control the data transmission according to the first AG information if it is detected that the conventional E-AGCH does not carry the first AG information of the UE, and if it is detected that the grant value detecting E-AGCH carries the first AG information of the UE.

In a third possible implementation manner, according to the second aspect, the detecting module is further configured to skip performing the data transmission if it is detected that the conventional E-AGCH does not carry the first AG information of the UE and that the grant value detecting E-AGCH carries second AG information of another UE except the UE.

According to the method for transmitting an AG value and the UE in embodiments of the present disclosure, the UE receives a conventional E-AGCH sent by a network side device, and receives a grant value detecting E-AGCH sent by the network side device, and the UE performs a data transmission operation according to the AG if the UE determines that at least one channel of the conventional E-AGCH and the grant value detecting E-AGCH carries an AG value of the UE. Using the technical solutions provided by the embodiments of the present disclosure, continuity of data transmission of the UE can be ensured, and transmission efficiency is improved.

### BRIEF DESCRIPTION OF DRAWINGS

To describe the technical solutions in the embodiments of the present disclosure or in the prior art more clearly, the following briefly introduces the accompanying drawings required for describing the embodiments or the prior art. The accompanying drawings in the following description show some embodiments of the present disclosure, and persons of ordinary skill in the art may still derive other drawings from these accompanying drawings without creative efforts.

FIG. 1 is a flowchart of a method for transmitting an AG value according to an embodiment of the present disclosure;

FIG. 2 is a flowchart of an interaction process between a network side device and a UE according to an embodiment of the present disclosure;

FIG. 3A is a schematic diagram of scheduling four UEs;

FIG. 3B is a schematic diagram of scheduling four UEs according to an embodiment of the present disclosure;

FIG. 4 is a schematic structural diagram of a UE according to an embodiment of the present disclosure;

FIG. 5 is a schematic structural diagram of another UE according to an embodiment of the present disclosure;

FIG. 6 is a flowchart of another method for transmitting an AG value according to an embodiment of the present disclosure;

FIG. 7 is a schematic structural diagram of still another UE according to an embodiment of the present disclosure;

FIG. 8 is a schematic structural diagram of yet another UE according to an embodiment of the present disclosure;

FIG. 9 is a flowchart of still another method for transmitting an AG value according to an embodiment of the present disclosure;

FIG. 10 is a schematic structural diagram of still yet another UE according to an embodiment of the present disclosure;

FIG. 11 is a flowchart of yet another method for transmitting an AG value according to an embodiment of the present disclosure;

FIG. 12 is a flowchart of still yet another method for transmitting an AG value according to an embodiment of the present disclosure; and

FIG. 13 is a flowchart of a further method for transmitting an AG value according to an embodiment of the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. The described embodiments are some but not all of the embodiments of the present disclosure. All other embodiments obtained by persons of ordinary skill in the art based on the embodiments of the present disclosure without creative efforts shall fall within the protection scope of the present disclosure.

Technologies described in this specification may be applied to various communications systems, for example, current second generation (2G) and third generation (3G) communications systems and a next-generation communications system, for example, a global system for mobile communications (GSM), a code division multiple access (CDMA) system, a time division multiple access (TDMA) system, a wideband code division multiple access (WCDMA) system, a frequency division multiple access (FDMA) system, an orthogonal frequency-division multiple access (OFDMA) system, a single-carrier FDMA (SC-FDMA) system, a general packet radio service (GPRS) system, a long term evolution (LTE) system, and other communications systems.

A UE involved in this application may be a wireless terminal or a wired terminal. The wireless terminal may refer to a device that provides voice and/or data connectivity for a user, a handheld device with a wireless connection function, or another processing device connected to a wireless modem. The wireless terminal may communicate with one or more core networks through a radio access network (RAN). The wireless terminal may be a mobile terminal, for example, a mobile phone (also referred to as a “cellular” phone) or a computer with a mobile terminal, and may be, for example, a portable, pocket-sized, handheld, computer built-in, or in-vehicle mobile apparatus, which exchanges voice and/or data with the RAN. For example, it may be a device such as a personal communication service (PCS) phone, a cordless telephone set, a session initiation protocol (SIP) phone, a wireless local loop (WLL) station, or a personal digital assistant (PDA). The wireless terminal may also be referred to as a system, a subscriber unit, a subscriber station, a mobile station, a mobile terminal, a remote station, an access point, a remote terminal, an access terminal, a user terminal, a user agent, a user device, or a UE.

A network side device involved in this application may be a base station, a radio network controller (RNC), or the like, or may be a functional module in the foregoing various devices on a RAN side.

The base station (for example, an access point) may be a device that communicates with the wireless terminal through one or more sectors on an air interface on an access network. The base station may be configured to perform mutual conversion between a received air frame and an Internet Protocol (IP) packet, serving as a router between the wireless terminal and another part of the access network, where the other part of the access network may include an IP network. The base station may further coordinate attribute management on the air interface. For example, the base station may be a base station (Base Transceiver Station (BTS)) in the GSM or the CDMA, or may be a base station (NodeB) in the WCDMA, or may be an evolved base station (evolved Node B: NodeB, eNB, or e-NodeB) in the LTE, which is not limited in this application.

The base station controller may be a base station controller (BSC) in the GSM or the CDMA, or may be a RNC in the WCDMA, which is not limited in this application.

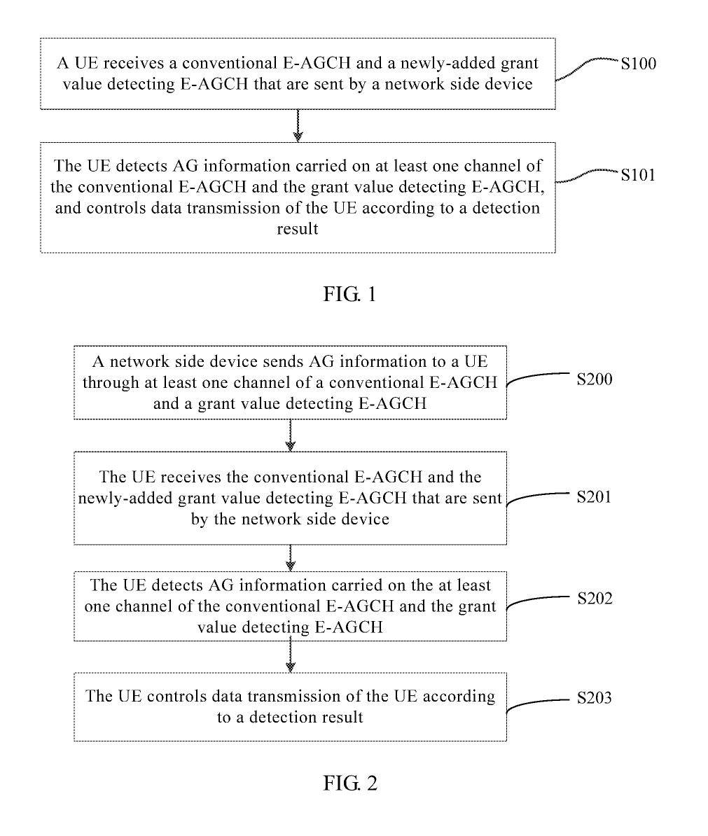

FIG. 1 is a flowchart of a method for transmitting an AG value according to an embodiment of the present disclosure. In this embodiment, a UE receives two channels, that is, a conventional E-AGCH and a grant value detecting E-AGCH, sent by a network side device, and the UE performs a data transmission operation according to the AG when determining that at least one channel of the conventional E-AGCH and the grant value detecting E-AGCH carries an AG of the UE. As shown in FIG. 1, the method for transmitting an AG value includes the following steps.

Step S100: A UE receives a conventional E-AGCH and a newly-added grant value detecting E-AGCH that are sent by a network side device.

Step S101: The UE detects AG information carried on the at least one channel of the conventional E-AGCH and the grant value detecting E-AGCH, and controls data transmission of the UE according to a detection result.

Furthermore, the UE may first receive the conventional E-AGCH sent by the network side device, where the conventional E-AGCH receive the newly-added grant value detecting E-AGCH sent by the network side device, where the newly-added grant value detecting E-AGCH is referred to as a grant value detecting E-AGCH for short below. It should be noted that, the conventional E-AGCH herein is the conventional E-AGCH in the prior art, and the grant value detecting E-AGCH is the new E-AGCH in the background. The foregoing conventional E-AGCH and grant value detecting E-AGCH are channels that are used by the network side device to send the AG information to the UE, and may occupy a same time-frequency resource or occupy different time-frequency resources, which is not limited herein.

Further, after receiving the foregoing two channels, that is, the conventional E-AGCH and the grant value detecting E-AGCH, the UE may detect the AG information carried on the at least one channel of the conventional E-AGCH and the grant value detecting E-AGCH, and control the data transmission of the UE according to the detection result.

Optionally, the UE controls the data transmission according to the first AG information on the conventional E-AGCH if the UE detects that the conventional E-AGCH carries first AG information, where the foregoing first AG information represents AG information of the UE, the UE controls the data transmission according to the first AG information on the grant value detecting E-AGCH if the UE does not detect the first AG information on the conventional E-AGCH, and detects that the grant value detecting E-AGCH carries the first AG information, the UE may control the data transmission separately according to the first AG information carried on the two E-AGCHs, or may control the data transmission only according to the first AG information carried on the conventional E-AGCH if the UE detects that both the conventional E-AGCH and the grant value detecting E-AGCH carry the AG information of the UE itself, and the UE may also control the data transmission according to the first AG information carried on an E-AGCH on which the data transmission that is being performed by the UE currently is started if the UE is performing the data transmission.

In this embodiment, a UE receives a conventional E-AGCH and a newly-added grant value detecting E-AGCH that are sent by a network side device, and detects AG information carried on at least one channel of the conventional E-AGCH and the grant value detecting E-AGCH, and controls data transmission of the UE according to a detection result. Therefore, continuity of the data transmission can be ensured, and transmission efficiency is improved.

FIG. 2 is a diagram of an interaction process between a network side device and a UE according to an embodiment of the present disclosure. In this embodiment, the network side device sends AG information to the UE through at least one channel of a conventional E-AGCH and a grant value detecting E-AGCH, and the UE simultaneously listens on the foregoing two E-AGCHs, detects the foregoing two E-AGCHs, and controls data transmission of the UE according to a detection result. As shown in FIG. 2, the interaction process includes the following steps.

Step S200: A network side device sends AG information to a UE through at least one channel of a conventional E-AGCH and a grant value detecting E-AGCH.

The foregoing step is performed by the network side device. In practice, the network side device may be a device that can communicate with the UE, such as a base station or a relay.

Furthermore, the network side device may deliver a scheduling permission value to the UE when scheduling the UE, to achieve an objective of scheduling uplink transmit power of the UE. In this embodiment, for any UE, the network side device may deliver the AG information to the UE through the at least one channel of the conventional E-AGCH and the grant value detecting E-AGCH. That is, the network side device may deliver the AG information to the UE through the conventional E-AGCH, may deliver the AG information to the UE through the grant value detecting E-AGCH, or may deliver the AG information to the UE through the conventional E-AGCH and the grant value detecting E-AGCH.

Further, for any UE, the foregoing AG information may be AG information of the UE itself, or may be AG information of another UE except the UE.

It should be noted that, in practice, the foregoing two E-AGCHs are channels that are used by the network side device to send the AG information to the UE, and may occupy a same time-frequency resource or occupy different time-frequency resources, which is not limited herein. Optionally, in a WCDMA system, the network side device may send the foregoing conventional E-AGCH and grant value detecting E-AGCH using an uplink high rise over thermal (RoT) dedicated secondary carrier.

Step S201: The UE receives the conventional E-AGCH and the newly-added grant value detecting E-AGCH that are sent by the network side device.

Description of the step S201 is same as that of step S100, and details are not described herein again.

Step S202: The UE detects AG information carried on the at least one channel of the conventional E-AGCH and the grant value detecting E-AGCH.

Furthermore, because the network side device sends the AG information to the UE through the at least one channel of the conventional E-AGCH and the grant value detecting E-AGCH, after receiving the foregoing two E-AGCHs, the UE may detect the AG information on the foregoing two E-AGCHs.

Further, because each UE has a dedicated identity (ID) for detecting an AG of the UE, the UE may decode the foregoing two E-AGCHs, to detect whether there is AG information that belongs to the UE on the two E-AGCHs. Furthermore, during detection, the UE may detect the conventional E-AGCH and the grant value detecting E-AGCH separately.

For the conventional E-AGCH, the UE only needs to detect whether there is the AG information that belongs to the UE on the conventional E-AGCH. If the UE fails in the decoding, it indicates that the conventional E-AGCH does not carry first AG information of the UE, and if the UE succeeds in the decoding, it indicates that the conventional E-AGCH carries the first AG information of the UE. It should be noted that, the UE detects that the conventional E-AGCH does not carry the first AG information of the UE which includes two situations: the conventional E-AGCH does not carry AG information, or the conventional E-AGCH carries AG information, but the AG information is not the foregoing first AG information but is second AG information of another UE except the UE.

For the grant value detecting E-AGCH, the UE may first detect whether there is AG information on the grant value detecting E-AGCH, and the UE further detects whether the AG information is the first AG information of the UE itself if there is AG information on the grant value detecting E-AGCH.

Further, the UE may first perform information detection on the grant value detecting E-AGCH, for example, detect a signal-to-noise ratio of the grant value detecting E-AGCH. It is considered that the grant value detecting E-AGCH carries the AG information if the signal-to-noise ratio is higher than a preset threshold, and it is considered that the grant value detecting E-AGCH does not carry the AG information if the signal-to-noise ratio is lower than the foregoing preset threshold. The UE decodes the grant value detecting E-AGCH when the UE detects that the grant value detecting E-AGCH carries the AG information. It indicates that the grant value detecting E-AGCH does not carry the first AG information of the UE if the UE fails in the decoding. Because the grant value detecting E-AGCH carries the AG information in this case, the UE may determine that the grant value detecting E-AGCH carries the second AG information of the other UE except the UE in this case. It indicates that the grant value detecting E-AGCH carries the first AG information of the UE if the UE succeeds in the decoding.

For the grant value detecting E-AGCH, the UE may also first detect whether the AG information on the grant value detecting E-AGCH is the first AG information of the UE, and the UE further detects whether the AG information is the second AG information of the other UE except the UE if the AG information on the grant value detecting E-AGCH is not the first AG information of the UE itself.

Further, the UE may first decode the grant value detecting E-AGCH, it indicates that the grant value detecting E-AGCH carries the first AG information of the UE if the UE succeeds in the decoding, and it indicates that the grant value detecting E-AGCH does not carry the first AG information of the UE if the UE fails in the decoding. In this case, the UE may further detect whether the AG information is the second AG information of the other UE except the UE. For example, the UE may further perform information detection on the grant value detecting E-AGCH, for example, detect a signal-to-noise ratio of the grant value detecting E-AGCH. It indicates that AG information on the grant value detecting E-AGCH is the second AG information of the other UE except the UE if the signal-to-noise ratio is higher than a preset threshold, and it indicates that the grant value detecting E-AGCH does not carry the AG information if the signal-to-noise ratio is lower than the foregoing preset threshold.

Certainly, an order in which the UE detects the foregoing two E-AGCHs is not limited herein. Optionally, in practice, the UE may first detect AG information carried on the conventional E-AGCH and then detect AG information carried on the grant value detecting E-AGCH according to a descending order of priorities of the conventional E-AGCH and the grant value detecting E-AGCH, the UE directly controls the data transmission according to an AG index value in the first AG information if the detection result is that the conventional E-AGCH carries the first AG information that belongs to the UE, and the UE controls the data transmission according to a detection result on the grant value detecting E-AGCH if the detection result is that the conventional E-AGCH does not carry the first AG information that belongs to the UE.

Optionally, the UE may also detect the AG information on the two E-AGCHs separately, and determine a data transmission operation of the UE according to a detection result, and an execution sequence is not limited herein. The UE performs a data transmission operation according to the AG information on the conventional E-AGCH without paying attention to a detection result on the grant value detecting E-AGCH if the UE detects the AG information of the UE on both the two E-AGCHs, or detects the AG information of the UE on the conventional E-AGCH and detects AG information of another UE on the grant value detecting E-AGCH, or detects the AG information of the UE on the conventional E-AGCH and does not detect the AG information on the grant value detecting E-AGCH.

Step S203: The UE controls data transmission of the UE according to a detection result.

Furthermore, after detecting the conventional E-AGCH and the grant value detecting E-AGCH, the UE may control the data transmission of the UE according to the detection result.

The following describes in detail, according to different results on detection performed by the UE on the foregoing two E-AGCHs in step S202, a process of controlling, by the UE, the data transmission of the UE.

(1) If the UE detects that the at least one channel of the conventional E-AGCH and the grant value detecting E-AGCH carries the first AG information of the UE, the UE controls the data transmission according to the foregoing first AG information.

Further, the UE controls the data transmission according to the foregoing first AG information if the UE detects that the conventional E-AGCH carries the first AG information of the UE, the UE controls the data transmission according to the foregoing first AG information if the UE detects that the conventional E-AGCH does not carry the foregoing first AG information, and detects that the grant value detecting E-AGCH carries the foregoing first AG information, and optionally, the UE may control the data transmission according to the first AG information carried on the conventional E-AGCH without paying attention to a detection result on the grant value detecting E-AGCH if the UE detects that the conventional E-AGCH carries the first AG information of the UE, and detects that the grant value detecting E-AGCH also carries the first AG information of the UE.

For example, controlling the data transmission according to the first AG information refers to that, if an AG value index in the first AG information is 0 or 1, it indicates stopping the data transmission, that is, if the UE is currently performing the data transmission, the data transmission is stopped, and the data transmission is still not performed if the UE does not perform the data transmission, it indicates different transmit power offsets if the AG value index in the first AG information is any integer between 2 and 31, the UE adjusts a transmit power offset of the current data transmission according to the foregoing first AG information if the UE is performing the data transmission, and the UE starts the data transmission according to a transmit power offset corresponding to the foregoing AG if the UE does not perform the data transmission.

(2) The UE does not perform the data transmission if the UE detects that the conventional E-AGCH does not carry the first AG information of the UE and that the grant value detecting E-AGCH carries the second AG information of the other UE except the UE.

Further, the UE does not perform the data transmission if the UE detects that grant value detecting E-AGCH of the UE carries the second AG information of the other UE except the UE and that the conventional E-AGCH does not carry the AG information, and the UE does not perform the data transmission if the UE detects that grant value detecting E-AGCH of the UE carries the second AG information of the other UE except the UE and that the conventional E-AGCH carries the second AG information of the other UE except the UE.

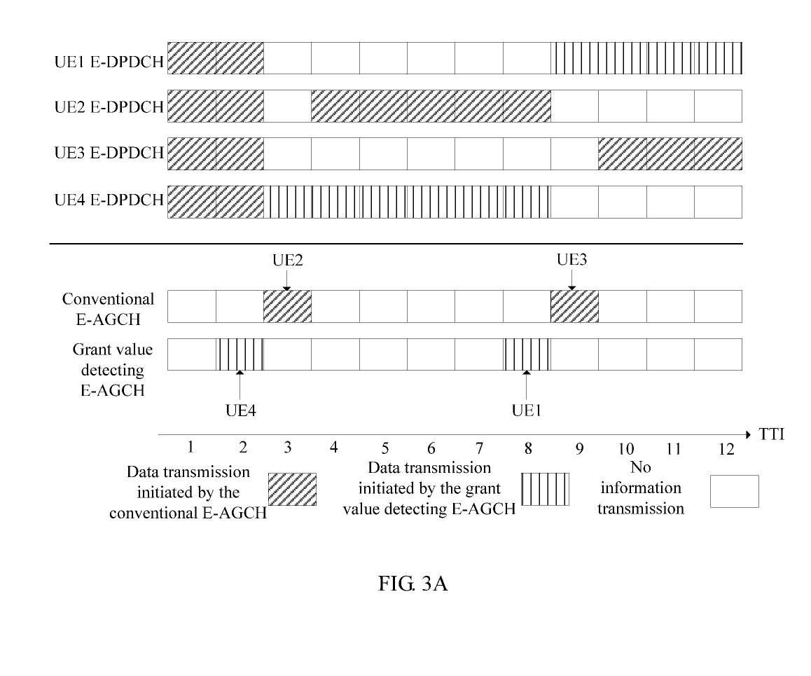

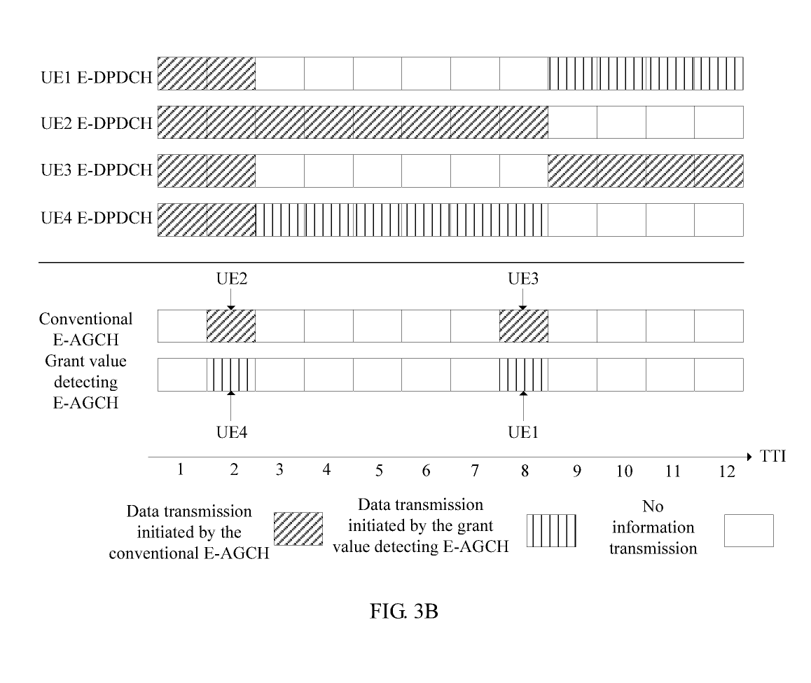

It should be noted that, that the UE does not perform the data transmission refers to that, if the UE is currently performing the data transmission, the data transmission is stopped, and if the UE does not perform the data transmission, the data transmission is still not performed. The foregoing interaction process between the network side device and the UE is described below using an example. FIG. 3A is a schematic diagram of scheduling four UEs, and FIG. 3B is a schematic diagram of scheduling four UEs according to an embodiment of the present disclosure. In FIG. 3A and FIG. 3B, 1 to 12 on a horizontal axis in the figures represent different timeslots, a network side device needs to schedule four UEs, that is, a UE1, a UE2, a UE3, and a UE4, data transmission corresponding to AG information received from a conventional E-AGCH is represented using an inclined-stripe square, data transmission corresponding to AG information received from a grant value detecting E-AGCH is represented using a cross-stripe square, a blank square on an E-DPDCH represents that a UE does not transmit data, and a blank square on an E-AGCH represents that the network side device does not send AG information. It should be noted that, the inclined-stripe square only represents that the data transmission of the UE is started by the AG information, received from the conventional E-AGCH, of the UE, but does not represent that an E-DPDCH to DPCCH transmit power offset thereof keeps unchanged. Similarly, the cross-stripe square only represents that the data transmission of the UE is started by the AG information, received from the grant value detecting E-AGCH, of the UE, but does not represent that an E-DPDCH to DPCCH transmit power offset thereof keeps unchanged. At the beginning, all the four UEs start data transmission according to respective AG information received from the conventional E-AGCH. That is, in a first timeslot and the second timeslot, the data transmission of all the foregoing four UEs is represented using inclined-stripe squares.

As shown in FIG. 3A, in the second timeslot, the network side device sends AG information of the UE4 through the grant value detecting E-AGCH. It can be known according to the description in the background that, in the third timeslot, the UE1, the UE2, and the UE3 receives AG information of another UE from the grant value detecting E-AGCH, that is, a new E-AGCH, the UE1, and therefore, the UE1, the UE2, and the UE3 stop their own data transmission. Therefore, in the third timeslot, only the UE4 performs data transmission according to the AG information received by the UE4 in the second timeslot. In this case, if the network side device needs to schedule the UE2, the network side device can re-start data transmission of the UE2 only by delivering AG information of the UE2 in the third timeslot through the conventional E-AGCH. However, for the UE2, the UE2 does not perform data transmission in the third timeslot. Therefore, a problem of data transmission interruption occurs.

Because the network side device does not send AG information in the following third to seventh timeslots, the UEs keep their current data transmission operations unchanged.

In the eighth timeslot, the network side device continues to send AG information of the UE1 through the grant value detecting E-AGCH, and data transmission of the UE1 may be re-started in a next timeslot. At the same time, the UE2 and the UE4 receive AG information of another UE from the grant value detecting E-AGCH, and therefore, the UE2 and the UE4 stop their own data transmission. In addition, in this case, if it further needs to schedule the UE3, AG information of the UE3 can only be delivered in the ninth timeslot through the conventional E-AGCH. However, for the UE3, the UE3 does not perform data transmission in the ninth timeslot. That is, only one UE performs data transmission in the timeslot. In conclusion, when the network side device performs UE switching in the third timeslot and the ninth timeslot, that is, when the UE2 and the UE4 are scheduled in the third timeslot, and the UE1 and the UE3 are scheduled in the ninth timeslot, data transmission of the UEs is interrupted.

Relatively, as shown in FIG. 3B, in the second timeslot, the network side device sends an AG information of the UE2 through the conventional E-AGCH, and sends AG information of the UE4 through the grant value detecting E-AGCH. Then, when the four UEs receive the foregoing two pieces of AG information in this case, the UEs have different data transmission operations separately. For the UE1 and the UE3, because the AG information on the two channels does not belong to the UE1 or the UE3, it can be known from the description of (2) of step S203 that, both the UE1 and the UE3 stops data transmission in a next timeslot. For the UE2, it can be known from the description of (1) of step S203 that, the UE2 receives its own AG information from the conventional E-AGCH in this case, and the AG information on the grant value detecting E-AGCH does not belong to the UE2. Therefore, the UE2 performs data transmission according to the AG information on the conventional E-AGCH, that is, continues, in a next timeslot, the data transmission performed in the second timeslot. However, a transmit power offset of the UE2 during the data transmission is a transmit power offset corresponding to the AG information received by the UE2 in the second timeslot. For the UE4, it can be known from the description of (1) of step S203 that, the UE4 receives its own AG information from the grant value detecting E-AGCH, and therefore, the UE4 performs data transmission in a next timeslot according to the AG information received by the UE4 in the second timeslot.

Because the network side device does not send AG information in the following third to seventh timeslots, the UEs keep their current data transmission operations unchanged.

In the eighth timeslot, the network side device sends an AG information of the UE3 through the conventional E-AGCH, and sends AG information of the UE1 through the grant value detecting E-AGCH. Then, when the four UEs receive the foregoing two pieces of AG information in this case, the UEs have different data transmission operations separately. For the UE1, because the UE1 only receives its own AG information from the grant value detecting E-AGCH, and since UE1 stopped data transmission in the third timeslot, the UE1 re-starts the data transmission in a next timeslot according to the AG information. For the UE2 and the UE4, because the AG information on the two channels does not belong to the UE2 or the UE4 in this case, it can be known from the foregoing description that, the UE2 and UE4 stop the data transmission in a next timeslot. For the UE3, the UE3 receives its own AG information from the conventional E-AGCH, the AG information on the grant value detecting E-AGCH does not belong to the UE3, and since the UE3 stopped the data transmission in the third timeslot, the UE3 performs the data transmission according to the AG information on the conventional E-AGCH, that is, re-starts the data transmission in a next timeslot according to the AG information.

It should be noted that, the four UEs in the foregoing example may be any UEs in a network, which is not limited herein. In addition, in the solution described in the example, the network side device may schedule the UE2 and the UE4 in the third timeslot, or switch the UE2 and the UE4 to the UE3 and the UE1 in the ninth timeslot. In practice, the network side device may select, according to an actual situation, to send AG information of a UE on the foregoing two E-AGCHs, to achieve an objective of flexibly scheduling UEs.

It can be seen from the foregoing example that, the network side device sends the AG information of the UE2 and the AG information of the UE4 to the UE2 and the UE4 respectively in the second timeslot through the conventional E-AGCH and the grant value detecting E-AGCH, and a priority rule between different E-AGCHs is pre-defined such that both the UE2 and the UE4 can perform data transmission according to their own AG information without data transmission interruption. That is, there is no idle timeslot during the data transmission of the UE2 and the UE4. Similarly, the network side device sends the AG information of the UE3 and the AG information of the UE1 to the UE3 and the UE1 respectively in the eighth timeslot through the conventional E-AGCH and the grant value detecting E-AGCH in order to ensure that both the UE3 and the UE1 can perform data transmission according to their own AG information without data transmission interruption when UEs are switched from the UE2 and the UE4 to the UE3 and the UE1, thereby ensuring continuity of the data transmission of the UEs and improving transmission efficiency.

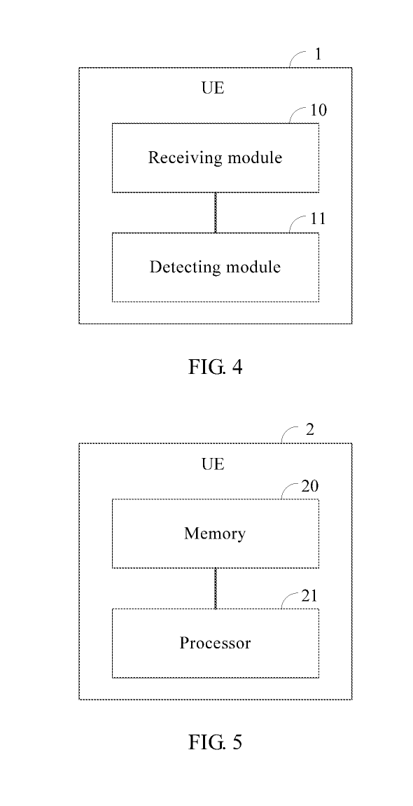

FIG. 4 is a schematic structural diagram of a UE according to an embodiment of the present disclosure. As shown in FIG. 4, the UE 1 includes a receiving module 10 and a detecting module 11.

Further, the receiving module 10 is configured to receive a conventional E-AGCH and a newly-added grant value detecting E-AGCH that are sent by a network side device, and the detecting module 11 is configured to detect AG information carried on at least one channel of the conventional E-AGCH and the grant value detecting E-AGCH, and control data transmission of the UE according to a detection result.

The detecting module 11 is further configured to control the data transmission according to the first AG information of the UE if it is detected that the at least one channel of the conventional E-AGCH and the grant value detecting E-AGCH carries first AG information of the UE.

The detecting module 11 is further configured to control the data transmission according to the first AG information of the UE if it is detected that the conventional E-AGCH carries the first AG information of the UE, and control the data transmission according to the first AG information if it is detected that the conventional E-AGCH does not carry the first AG information of the UE, and it is detected that the grant value detecting E-AGCH carries the first AG information of the UE.

The detecting module 11 is further configured to skip performing the data transmission if it is detected that the conventional E-AGCH does not carry the first AG information of the UE and that the grant value detecting E-AGCH carries second AG information of another UE except the UE.

The detecting module 11 is further configured to, first detect AG information carried on the conventional E-AGCH and then detect AG information carried on the grant value detecting E-AGCH according to a descending order of priorities of the conventional E-AGCH and the grant value detecting E-AGCH.

In this embodiment, a UE 1 receives a conventional E-AGCH and a newly-added grant value detecting E-AGCH that are sent by a network side device, and detects AG information carried on at least one channel of the conventional E-AGCH and the grant value detecting E-AGCH, and controls data transmission of the UE 1 according to a detection result. Therefore, continuity of the data transmission can be ensured, and transmission efficiency is improved.

FIG. 5 is a schematic structural diagram of another UE according to an embodiment of the present disclosure. As shown in FIG. 5, the UE 2 includes a memory 20 and a processor 21.

Further, the memory 20 is configured to store an instruction, and the processor 21 is configured to run the instruction stored in the memory 20, to perform the method for transmitting an AG value according to the embodiment corresponding to FIG. 1.

In this embodiment, a UE 2 receives a conventional E-AGCH and a newly-added grant value detecting E-AGCH that are sent by a network side device, and detects AG information carried on at least one channel of the conventional E-AGCH and the grant value detecting E-AGCH, and controls data transmission of the UE 2 according to a detection result. Therefore, continuity of the data transmission can be ensured, and transmission efficiency is improved.

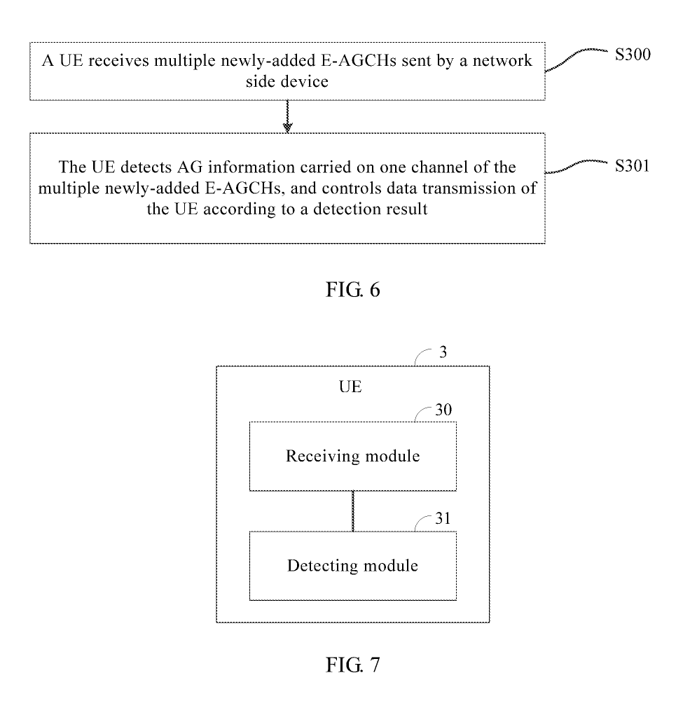

FIG. 6 is a flowchart of another method for transmitting an AG value according to an embodiment of the present disclosure. In this embodiment, a UE receives multiple newly-added E-AGCHs sent by a network side device, determines that at least one channel of the multiple newly-added E-AGCHs carries an AG of the UE, and performs a data transmission operation according to the AG. As shown in FIG. 6, the foregoing method for transmitting an AG value includes the following steps.

Step S300: A UE receives multiple newly-added E-AGCHs sent by a network side device.

Step S301: The UE detects AG information carried on one channel of the multiple newly-added E-AGCHs, and controls data transmission of the UE according to a detection result.

It should be noted that, the newly-added E-AGCH herein is the new E-AGCH in the background, and it may also become a newly-added grant value detecting E-AGCH. A difference between the newly-added E-AGCH and a conventional E-AGCH lies in that, for the conventional E-AGCH, when a UE detects an AG that belongs to the UE on the conventional E-AGCH, the UE controls data transmission of the UE according to the AG on the channel, while for the newly-added E-AGCH, a UE not only may detect the AG that belongs to the UE on the newly-added E-AGCH and control data transmission of the UE according to the detected AG, but also may detect an AG of another UE on the newly-added E-AGCH and stop, when detecting the AG of the other UE, data transmission that is performed currently. The foregoing multiple newly-added E-AGCHs are channels that are used by the network side device to send the AG information to the UE, and may occupy a same time-frequency resource or occupy different time-frequency resources, which is not limited herein.

Further, after receiving the foregoing multiple newly-added E-AGCHs, the UE may detect AG information carried on one channel of the multiple newly-added E-AGCHs, and controls the data transmission of the UE according to the detection result.

Optionally, the UE controls the data transmission according to the first AG information if the UE detects that one channel of the multiple newly-added E-AGCHs carries first AG information, where the first AG information represents AG information of the UE, and the UE does not perform the data transmission if the UE detects that none of the multiple newly-added E-AGCHs carries the first AG information of the UE and that one channel of the multiple newly-added E-AGCHs carries second AG information of another UE except the UE. It should be noted that, that the UE does not perform data transmission refers to that, if the UE is currently performing the data transmission, the data transmission is stopped, and if the UE does not perform the data transmission, the data transmission is still not performed.

In this embodiment, a UE receives multiple newly-added E-AGCHs sent by a network side device, and detects AG information carried on at least one channel of the multiple newly-added E-AGCHs, and controls data transmission of the UE according to a detection result. Therefore, continuity of the data transmission can be ensured, and transmission efficiency is improved.

FIG. 7 is a schematic structural diagram of still another UE according to an embodiment of the present disclosure. As shown in FIG. 7, the UE 3 includes a receiving module 30 and a detecting module 31.

The receiving module 30 is configured to receive multiple newly-added E-AGCHs sent by a network side device.

The detecting module 31 is configured to detect AG information carried on one channel of the multiple newly-added E-AGCHs, and control data transmission of the UE according to a detection result.

The detecting module 31 is further configured to control the data transmission of the UE according to the first AG information when it is detected that one channel of the multiple newly-added E-AGCHs carries first AG information of the UE, or control the UE to skip performing the data transmission when it is detected that none of the multiple newly-added E-AGCHs carries the first AG information of the UE and that one channel of the multiple newly-added E-AGCHs carries second AG information of another UE except the UE.

In this embodiment, a UE 3 receives multiple newly-added E-AGCHs sent by a network side device, and detects AG information carried on at least one channel of the multiple newly-added E-AGCHs, and controls data transmission of the UE 3 according to a detection result. Therefore, continuity of the data transmission can be ensured, and transmission efficiency is improved.

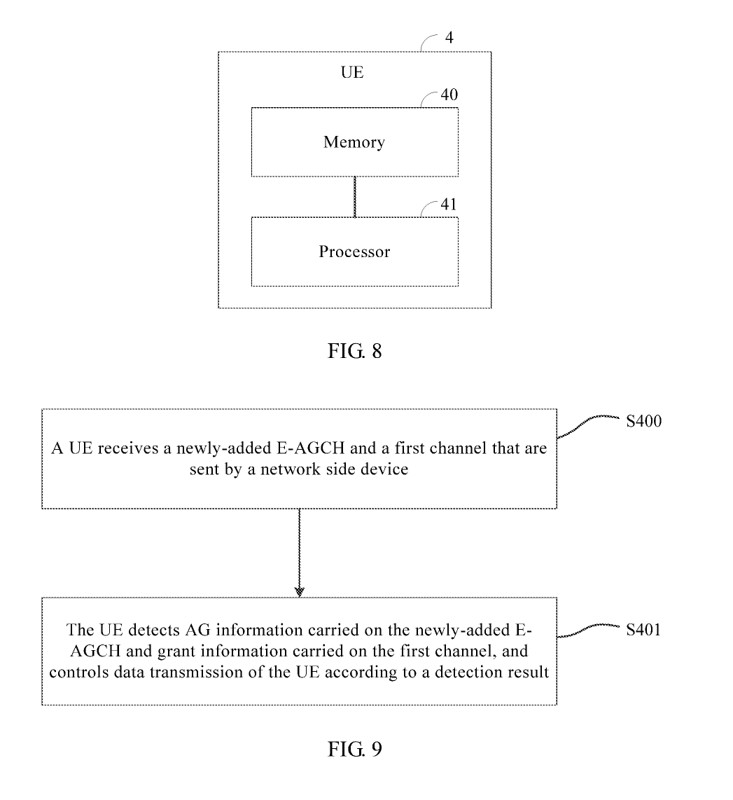

FIG. 8 is a schematic structural diagram of yet another UE according to an embodiment of the present disclosure. As shown in FIG. 8, the UE 4 includes a memory 40 and a processor 41.

Further, the memory 40 is configured to store an instruction, and the processor 41 is configured to run the instruction stored in the memory 40, to perform the method for transmitting an AG value according to the embodiment corresponding to FIG. 6, that is, steps S300, S301, and the like.

In this embodiment, a UE 4 receives multiple newly-added E-AGCHs sent by a network side device, and detects AG information carried on one channel of the multiple newly-added E-AGCHs, and controls data transmission of the UE 4 according to a detection result. Therefore, continuity of the data transmission can be ensured, and transmission efficiency is improved.

FIG. 9 shows still another method for transmitting an AG value according to an embodiment of the present disclosure, where the method includes the following steps.

Step S400: A UE receives a newly-added E-AGCH and a first channel that are sent by a network side device.

Step S401: The UE detects AG information carried on the newly-added E-AGCH and grant information carried on the first channel, and controls data transmission of the UE according to a detection result.

Further, it should be noted that, the newly-added E-AGCH herein is the new E-AGCH in the background. The UE stops data transmission that is performed currently when detecting an AG of another UE on the newly-added E-AGCH. In addition, in the prior art, when controlling the data transmission, the UE maintains a serving grant (SG) value, and then controls the data transmission according to the SG value. The SG value is generally used to calculate a power upper limit value with which the UE may send scheduled data. The UE updates the SG value maintained by the UE with the AG value, and then controls the data transmission when the network side device notifies the UE of an AG value. The detection result of step S401 may include the following several situations.

S401A: The UE controls the data transmission according to the first AG information when the UE detects that the newly-added E-AGCH carries first AG information of the UE.

S401B: The UE controls the data transmission according to a detection result of the grant information carried on the first channel when the UE detects that the newly-added E-AGCH carries second AG information of another UE except the UE.

S401C: The UE controls the data transmission according to a detection result of the grant information carried on the first channel when the UE detects that the newly-added E-AGCH does not carry any information.

In a possible implementation manner, the situation of S401B may further include that the UE obtains an updated SG value according to the grant information and a current SG value, and controls the data transmission according to the updated SG value when the UE detects that the newly-added E-AGCH carries the second AG information of the other UE except the UE and detects that the first channel carries the grant information, and the UE stops the data transmission when the UE detects that the newly-added E-AGCH carries the second AG information of the other UE except the UE and detects that the first channel does not carry the grant information, where the grant information instructs to increase or decrease the current SG value, to obtain the updated SG value. It should be noted that, an enhanced-dedicated channel (E-DCH) relative grant channel (E-RGCH) may be reused as the first channel herein. For example, the grant information carried by the E-RGCH may be instruction information, namely, “+1” or “−1”, where +1 instructs to increase the SG value currently maintained by the UE, and −1 instructs to decrease the SG value currently maintained by the UE. Persons skilled in the art should know that, an amplitude of the increasing or decreasing may be specified in a protocol. It should be known that, the E-RGCH may be represented using a channelization code and a signature sequence, and different E-RGCHs may be distinguished using different channelization codes, or may be distinguished using different signature sequences, or may be distinguished using different channelization codes and different signature sequences at the same time. A conventional E-RGCH may be used to adjust a value of an SG In this implementation manner, the conventional E-RGCH may instruct the UE to increase or decrease a current SG according to a RG value, to obtain a new SG value if the conventional E-RGCH is reused as the first channel. In addition, a new E-RGCH may further be used as the first channel, that is, a network allocates two E-RGCHs to each UE: one is the conventional E-RGCH, used to adjust the value of the SG, and the other is the new E-RGCH, specially used to instruct the UE not to stop the data transmission when the UE detects that the newly-added E-AGCH carries the second AG information of the other UE except the UE, and to control a value of a grant that is used when the data transmission is performed.

In another possible implementation manner, the situation of S401B may further include that the UE controls the data transmission according to the grant information when the UE detects that the newly-added E-AGCH carries the second AG information of the other UE except the UE and detects that the first channel carries the grant information, where the grant information instructs to continue performing the transmission according to a current SG value of the UE, and the UE stops the data transmission when the UE detects that the newly-added E-AGCH carries the second AG information of the other UE except the UE and that the first channel does not carry the grant information.

In this case, if the first channel is a conventional E-RGCH, the E-RGCH is used to instruct to continue performing the transmission according to the current SG value of the UE when the UE detects that the newly-added E-AGCH carries the second AG information of the other UE except the UE, and the E-RGCH maintains an original definition, and is used to adjust a value of an SG when the UE detects that the newly-added E-AGCH does not carry any information. If the first channel is a new E-RGCH, that is, a network allocates two E-RGCHs to each UE: one is the conventional E-RGCH, used to adjust the value of the SG, and the other is the new E-RGCH, specially used to instruct the UE to continue performing the transmission according to the current SG value of the UE when the UE detects that the newly-added E-AGCH carries the second AG information of the other UE except the UE, and when the UE detects that the newly-added E-AGCH does not carry any information, the new E-RGCH is ineffective, and a user may not pay attention to information carried on the new E-RGCH even if the user receives the new E-RGCH.

Further, when a network side device delivers an E-AGCH that carries the second AG information of the other UE except the UE, information, namely “+1” or “−1”, may be mapped on the E-RGCH in a fixed manner, and the UE is notified in advance, in a manner of protocol predefining or delivering using network side high-layer signaling, or the like, of whether the information is mapped in order to improve a probability that the UE detects grant information on the E-RGCH. The E-RGCH herein includes the conventional E-RGCH or the new E-RGCH.

In still another possible implementation manner, the situation of S401B may further include that the UE stops the data transmission when the UE detects that the newly-added E-AGCH carries the second AG information of the other UE except the UE and detects that the first channel carries the grant information, where the grant information instructs to stop the data transmission, and the UE continues performing the data transmission according to a current SG value when the UE detects that the newly-added E-AGCH carries the second AG information of the other UE except the UE and that the first channel does not carry the grant information.

In this case, if the first channel is a conventional E-RGCH, the E-RGCH is used to instruct the UE to stop the data transmission when the UE detects that the newly-added E-AGCH carries the second AG information of the other UE except the UE, and the E-RGCH maintains an original definition, and is used to adjust a value of an SG when the UE detects that the newly-added E-AGCH does not carry any information. If the first channel is a new E-RGCH, that is, a network allocates two E-RGCHs to each UE: one is the conventional E-RGCH, used to adjust the value of the SG, and the other is the new E-RGCH, specially used to instruct the UE to stop the data transmission when the UE detects that the newly-added E-AGCH carries the second AG information of the other UE except the UE, and when the UE detects that the newly-added E-AGCH does not carry any information, the new E-RGCH is ineffective, and a user may not pay attention to information carried on the new E-RGCH even if the user receives the new E-RGCH.

Further, when a network side device delivers an E-AGCH that carries the second AG information of the other UE except the UE, information, namely “+1” or “−1”, may be mapped on the E-RGCH in a fixed manner, and the UE is notified in advance, in a manner of protocol predefining or delivering using network side high-layer signaling, or the like, of whether the information is mapped in order to improve a probability that the UE detects grant information on the E-RGCH. The E-RGCH herein includes the conventional E-RGCH or the new E-RGCH.

In yet another possible implementation manner, the situation of S401B includes that the UE continues performing the transmission according to a current SG value when the UE detects that the newly-added E-AGCH carries the second AG information of the other UE except the UE and detects that the first channel carries the grant information, and the grant information is a first grant instruction, and the UE stops the data transmission when the UE detects that the newly-added E-AGCH carries the second AG information of the other UE except the UE and detects that the first channel carries the grant information, and the grant information is a second grant instruction, where the first grant instruction instructs the UE to continue performing the data transmission according to the current SG value, and the second grant instruction instructs the UE to stop performing the data transmission.

In this case, if the first channel is a conventional E-RGCH, the E-RGCH is used to instruct the UE to continue or stop the data transmission when the UE detects that the newly-added E-AGCH carries the second AG information of the other UE except the UE, and the E-RGCH maintains an original definition, and is used to adjust a value of an SG when the UE detects that the newly-added E-AGCH does not carry any information. If the first channel is a new E-RGCH, that is, a network allocates two E-RGCHs to each UE: one is the conventional E-RGCH, used to adjust the value of the SG, and the other is the new E-RGCH, specially used to instruct the UE to continue or stop the data transmission when the UE detects that the newly-added E-AGCH carries the second AG information of the other UE except the UE, and when the UE detects that the newly-added E-AGCH does not carry any information, the new E-RGCH is ineffective, and a user may not pay attention to information carried on the new E-RGCH even if the user receives the new E-RGCH.

Further, when the first channel is an E-RGCH, grant information sent by the E-RGCH may be divided into a first grant instruction and a second grant instruction, and the UE is notified of the first grant instruction and the second grant instruction in advance in a manner of protocol predefining or delivering using network side high-layer signaling in order to improve a probability that the UE detects grant information on the E-RGCH. Exemplarily, when the first grant instruction is “+1”, the second grant instruction is “−1” correspondingly, or when the first grant instruction is “−1”, the second grant instruction is “+1” correspondingly. The E-RGCH herein includes the conventional E-RGCH or the new E-RGCH.

Using the method in this embodiment, when multi-user transmission is supported, it is avoided that AGs are frequently delivered to re-start interrupted data transmission of a UE, and a downlink signaling overhead is reduced, and a data transmission interval of the UE caused because multiple AGs cannot be delivered simultaneously is avoided, and an uplink network capacity is improved.

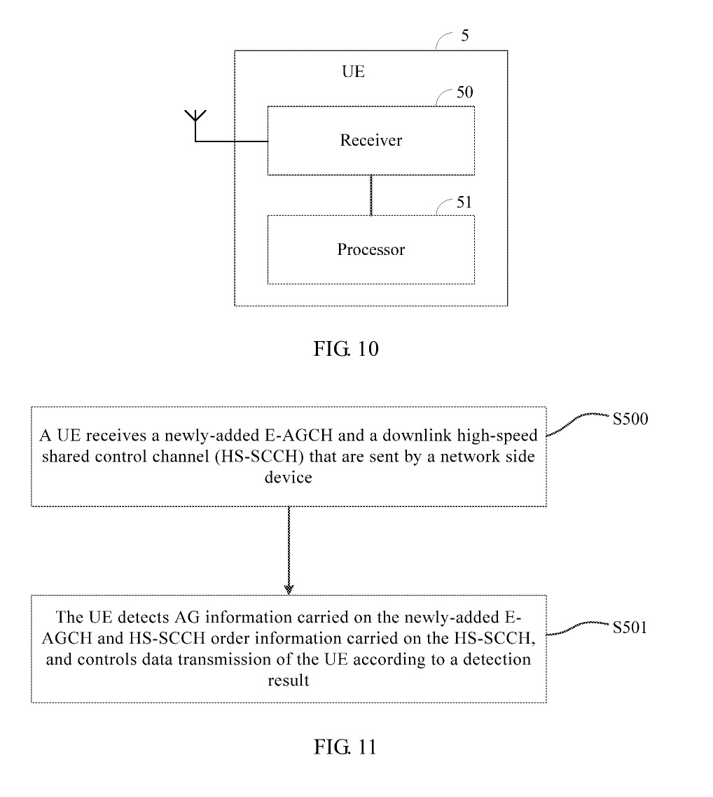

FIG. 10 shows still yet another UE 5 according to an embodiment of the present disclosure, where the UE 5 includes a receiver 50 configured to receive a newly-added E-AGCH and a first channel that are sent by a network side device, and a processor 51 configured to detect AG information carried on the newly-added E-AGCH and grant information carried on the first channel, and control data transmission of the UE according to a detection result.

In this embodiment, the processor 51 is further configured to control the data transmission according to the first AG information when it is detected that the newly-added E-AGCH carries first AG information of the UE, control the data transmission according to a detection result of the grant information carried on the first channel when it is detected that the newly-added E-AGCH carries second AG information of another UE except the UE, and control the data transmission according to the detection result of the grant information carried on the first channel when it is detected that the newly-added E-AGCH does not carry any information.

In an implementation manner, when the processor 51 detects that the newly-added E-AGCH carries the second AG information of the other UE except the UE, the processor 51 may be further configured to obtain an updated SG value according to the grant information and a current SG value, and control the data transmission according to the updated SG value when it is detected that the first channel carries the grant information, or stop the data transmission when it is detected that the first channel does not carry the grant information, where the grant information instructs to increase or decrease the current SG value. For example, when an E-RGCH is reused as the first channel, the grant information carried by the E-RGCH may be two pieces of instruction information, namely, “+1” or “−1”, where +1 instructs to increase the SG value currently maintained by the UE, and −1 instructs to decrease the SG value currently maintained by the UE.

In another implementation manner, when the processor 51 detects that the newly-added E-AGCH carries the second AG information of the other UE except the UE, the processor 51 may be further configured to control the data transmission according to the grant information when it is detected that the first channel carries the grant information, or stop the data transmission when it is detected that the first channel does not carry the grant information, where the grant information instructs to continue performing the transmission according to a current SG value of the UE.

In still another implementation manner, when the processor 51 detects that the newly-added E-AGCH carries the second AG information of the other UE except the UE, the processor 51 may be further configured to stop the data transmission when it is detected that the first channel carries the grant information, where the grant information instructs to stop the data transmission, continue performing the data transmission according to a current SG value when it is detected that the first channel does not carry the grant information, perform the data transmission according to the current SG value when it is detected that the first channel carries the grant information, and the grant information is a first grant instruction, and stop the data transmission when it is detected that the first channel carries the grant information, and the grant information is a second grant instruction, where the first grant instruction is used to instruct to continue performing the data transmission according to the current SG value, and the second grant instruction is used to instruct to stop performing the data transmission.

According to the UE provided by this embodiment, when multi-user transmission is supported, it is avoided that AGs are frequently delivered to re-start interrupted data transmission of the UE, and a downlink signaling overhead is reduced, and a data transmission interval of the UE caused because multiple AGs cannot be delivered simultaneously is avoided, and an uplink network capacity is improved.

FIG. 11 shows yet another method for transmitting an AG value according to an embodiment of the present disclosure, where the method includes the following steps.

Step S500: A UE receives a newly-added E-AGCH and a downlink high speed-shared control channel (HS-SCCH) that are sent by a network side device.

Step S501: The UE detects AG information carried on the newly-added E-AGCH and HS-SCCH order information carried on the HS-SCCH, and controls data transmission of the UE according to a detection result.

In an implementation manner, Step S501 may further include continuing performing, by the UE, the data transmission according to a current SG value when the UE detects that the newly-added E-AGCH carries second AG information of another UE except the UE, and when the UE detects that the HS-SCCH order information carried on the HS-SCCH instructs the UE to continue the transmission, and stopping, by the UE, the data transmission when the UE detects that the newly-added E-AGCH carries the second AG information of the other UE except the UE, and when the UE detects that the HS-SCCH does not carry the HS-SCCH order information.

In another implementation manner, step S501 may further include stopping, by the UE, the data transmission when the UE detects that the newly-added E-AGCH carries second AG information of another UE except the UE, and when the UE detects that HS-SCCH order information carried on the HS-SCCH instructs the UE to stop the data transmission, and continuing performing, by the UE, the data transmission according to a current SG value when the UE detects that the newly-added E-AGCH carries the second AG information of the other UE except the UE, and when the UE detects that the HS-SCCH does not carry the HS-SCCH order information. It can be seen that, a difference between this implementation manner and the previous implementation manner lies in whether the HS-SCCH order information instructs to continue transmission or stop transmission.

It should be noted that, the UE in this embodiment may further include a receiver and a processor, which respectively perform functions of steps S500 and S501. Reference may be made to division of the UE in FIG. 10, and details are not described herein again.

Using the method in this embodiment, when multi-user transmission is supported, it is avoided that AGs are frequently delivered to re-start interrupted data transmission of a UE, and a downlink signaling overhead is reduced, and a data transmission interval of the UE caused because multiple AGs cannot be delivered simultaneously is avoided, and an uplink network capacity is improved.

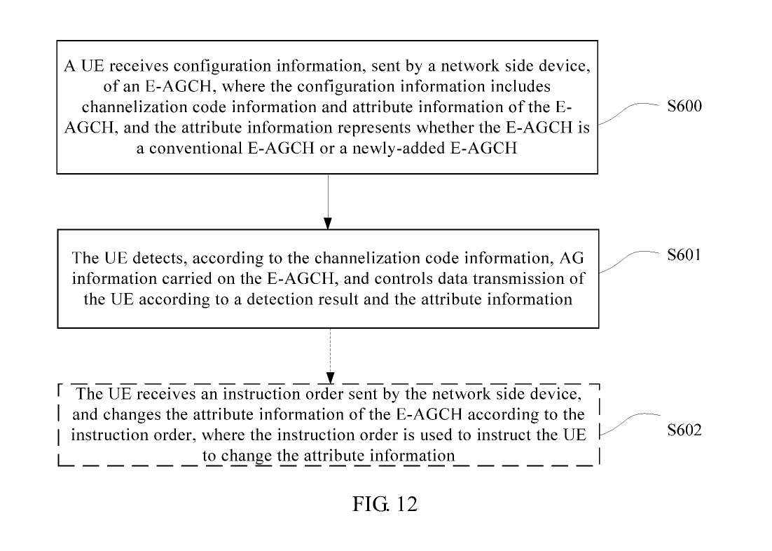

FIG. 12 shows still yet another method for transmitting an AG value according to an embodiment of the present disclosure, where the method includes the following steps.

Step S600: A UE receives configuration information, sent by a network side device, of an E-AGCH, where the configuration information includes channelization code information and attribute information of the E-AGCH, and the attribute information represents whether the E-AGCH is a conventional E-AGCH or a newly-added E-AGCH.

Step S601: The UE detects, according to the channelization code information, AG information carried on the E-AGCH, and controls data transmission of the UE according to a detection result and the attribute information.

In step S601, controlling the data transmission of the UE according to a detection result and the attribute information may further include updating a current SG value using the AG information, and performing the data transmission according to an updated SG value when the attribute information indicates that the E-AGCH is a conventional E-AGCH, and the UE detects the AG information on the E-AGCH, continuing performing the data transmission according to the current SG value when the attribute information indicates that the E-AGCH is a conventional E-AGCH, and the UE does not detect the AG information on the E-AGCH, and keeping a state of no data transmission unchanged if no data transmission is performed currently, updating the current SG value using the AG information, and performing the data transmission according to an updated SG value when the attribute information indicates that the E-AGCH is a newly-added E-AGCH, and the UE detects the AG information of the UE on the E-AGCH, stopping the data transmission when the attribute information indicates that the E-AGCH is a newly-added E-AGCH, and the UE detects AG information of another UE except the UE on the E-AGCH, and keeping a state of no data transmission unchanged if no data transmission is performed currently, continuing performing the data transmission according to the current SG value when the attribute information indicates that the E-AGCH is a newly-added E-AGCH, and the UE does not detect the AG information on the E-AGCH, and keeping a state of no data transmission unchanged if no data transmission is performed currently.

The method may further include step S602: The UE receives an instruction order sent by the network side device, and changes the attribute information of the E-AGCH according to the instruction order, where the instruction order is used to instruct the UE to change the attribute information.

In specific implementation, the attribute information may be changed in two manners.

Manner 1: The instruction order explicitly indicates whether attribute information of a changed E-AGCH is a conventional E-AGCH or a newly-added E-AGCH, after receiving the instruction order, the UE changes the original attribute information of the E-AGCH according to the instruction order.

Manner 2: The instruction order indicates that the original attribute information of the E-AGCH needs to be changed, that is, the conventional E-AGCH is changed to a newly-added E-AGCH if the unchanged E-AGCH is a conventional E-AGCH, and/or, the newly-added E-AGCH is changed to the conventional E-AGCH if the unchanged E-AGCH is a newly-added E-AGCH.

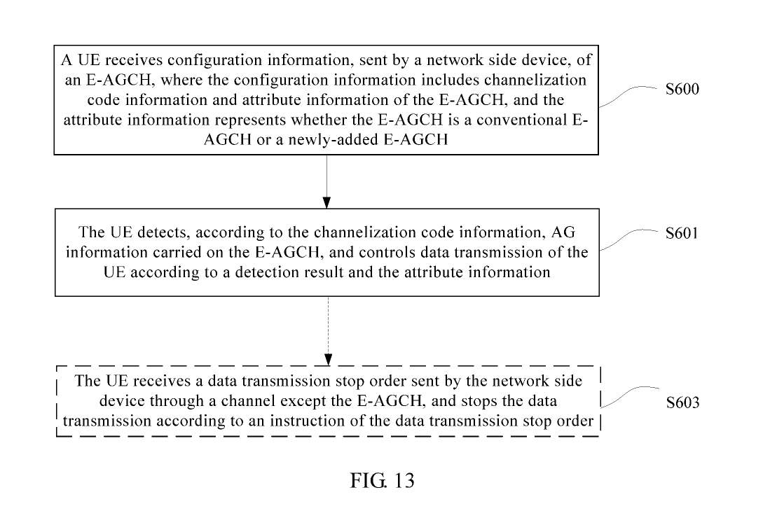

In another implementation manner of this embodiment, as shown in FIG. 13, the method may further include step S603: The UE receives a data transmission stop order sent by the network side device through a channel except the E-AGCH, and stops the data transmission according to an instruction of the data transmission stop order.

In specific implementation, the channel except the E-AGCH may be an E-RGCH or an HS-SCCH.

Information carried on the E-RGCH may be “+1” or “−1” when the channel is the E-RGCH, which may include a conventional E-RGCH or a new E-RGCH. The UE stops the data transmission as long as the UE receives a corresponding E-RGCH for transferring the data transmission stop order. In addition, a network side device may also map information, namely, “+1” or “−1”, on the E-RGCH in a fixed manner, and the UE is notified in advance, in a manner of protocol predefining or delivering using network side high-layer signaling, or the like, of whether the information is mapped in order to improve a probability that the UE detects the data transmission stop order on the E-RGCH.

When the channel is the HS-SCCH, the data transmission stop order may be delivered in a manner of HS-SCCH order.

It should be noted that, in the foregoing implementation manner, step S602 and step S603 are not necessary, and step S602 and step S603 may be separately combined with step S600 and step S601, or, all of step S600, step S601, step S602, and step S603 may be included in an implementation manner, which is not limited in this embodiment.

It should be noted that, the UE in this embodiment may further include a receiver, which performs corresponding functions of steps S600, S602 and/or S603, and a processor, which performs a function of step S601. Reference may be made to division of the UE in FIG. 10, and details are not described herein again. Persons skilled in the art should know that, that the receiver performs functions or a function of steps S602 and/or S603 herein mainly refers to acquiring a corresponding order from a channel, and a further function performed according to an instruction of the order is still performed by the processor.

Using the method in this embodiment, when multi-user transmission is supported, it is avoided that AGs are frequently delivered to re-start interrupted data transmission of a UE, and a downlink signaling overhead is reduced, and a data transmission interval of the UE caused because multiple AGs cannot be delivered simultaneously is avoided, and an uplink network capacity is improved.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes any medium that can store program code, such as a read-only memory (ROM), a random-access memory (RAM), a magnetic disk, or an optical disc.

Finally, it should be noted that the foregoing embodiments are merely intended for describing the technical solutions of the present disclosure, rather than limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, as long as such modifications or replacements do not cause the essence of corresponding technical solutions to depart from the scope of the technical solutions of the embodiments of the present disclosure.

What is claimed is:

1. A method for transmitting an absolute grant (AG) value, the method comprising:
receiving, by a user equipment, a conventional enhanced-absolute grant channel (E-AGCH) and a newly-added grant-value-detecting E-AGCH that are sent by a network side device;
detecting, by the user equipment, AG information carried on at least one channel of the conventional E-AGCH and the newly-added grant value detecting E-AGCH; and
controlling, by the user equipment, data transmission of the user equipment according to a detection result.

2. The method according to claim 1, wherein the detecting and the controlling comprises controlling, by the user equipment, the data transmission according to a first AG information of the user equipment when the user equipment detects that the at least one channel of the conventional E-AGCH and the grant-value-detecting E-AGCH carries the first AG information of the user equipment.

3. The method according to claim 2, wherein controlling the data transmission comprises:
controlling, by the user equipment, the data transmission according to the first AG information of the user equipment when the user equipment detects that the conventional E-AGCH carries the first AG information of the user equipment; and
controlling, by the user equipment, the data transmission according to the first AG information when the user equipment detects that the conventional E-AGCH does not carry the first AG information of the user equipment, and detects that the grant value detecting E-AGCH carries the first AG information of the user equipment.

4. The method according to claim 1, wherein the detecting comprises skipping performing, by the user equipment, the data transmission when the user equipment detects that the conventional E-AGCH does not carry first AG information of the user equipment and that the newly-added grant value detecting E-AGCH carries second AG information of another user equipment except the user equipment.

5. A user equipment comprising:
a receiver configured to receive a conventional enhanced-absolute grant channel (E-AGCH) and a newly-added grant-value-detecting E-AGCH that are sent by a network side device; and
a processor coupled to the receiver and configured to:
detect absolute grant (AG) information carried on at least one channel of the conventional E-AGCH and the grant-value-detecting E-AGCH; and
control data transmission of the user equipment according to a detection result.

6. The user equipment according to claim 5, wherein the processor is further configured to control the data transmission according to a first AG information of the user equipment when it is detected that the at least one channel of the conventional E-AGCH and the grant-value-detecting E-AGCH carries the first AG information of the user equipment.

7. The user equipment according to claim 6, wherein the processor is further configured to:
control the data transmission according to the first AG information of the user equipment when it is detected that the conventional E-AGCH carries the first AG information of the user equipment; and
control the data transmission according to the first AG information when it is detected that the conventional E-AGCH does not carry the first AG information of the user equipment and when it is detected that the grant-value-detecting E-AGCH carries the first AG information of the user equipment.

8. The user equipment according to claim 5, wherein the processor is further configured to skip performing the data transmission when it is detected that the conventional E-AGCH does not carry a first AG information of the user equipment and that the grant-value-detecting E-AGCH carries a second AG information of another user equipment except the user equipment.

9. A method for transmitting an absolute grant (AG) value, the method comprising:
receiving, by a user equipment, a newly-added enhanced-absolute grant channel (E-AGCH) and a first channel that are sent by a network side device;
detecting, by the user equipment, AG information carried on the E-AGCH and grant information carried on the first channel; and
controlling data transmission of the user equipment according to a detection result.

10. The method according to claim 9, wherein the detecting and the controlling comprises controlling, by the user equipment, the data transmission according to a detection result of the grant information carried on the first channel when the user equipment detects that the newly-added E-AGCH carries a second AG information of another user equipment except the user equipment.

11. The method according to claim 10, wherein the controlling the data transmission comprises:
obtaining, by the user equipment, an updated serving grant value according to the grant information and a current serving grant value when the user equipment detects that the first channel carries the grant information;
controlling the data transmission according to the updated serving grant value; and
stopping, by the user equipment, the data transmission when the user equipment detects that the first channel does not carry the grant information, wherein the grant information instructs to increase or decrease the current serving grant value.

12. The method according to claim 10, wherein controlling the data transmission comprises:
controlling, by the user equipment, the data transmission according to the grant information when the user equipment detects that the first channel carries the grant information, wherein the grant information instructs to continue performing the data transmission according to a current serving grant value of the user equipment; and
stopping, by the user equipment, the data transmission when the user equipment detects that the first channel does not carry the grant information.

13. The method according to claim 10, wherein controlling the data transmission comprises:
stopping, by the user equipment, the data transmission when the user equipment detects that the first channel carries the grant information, wherein the grant information instructs to stop the data transmission; and
continuing performing, by the user equipment, the data transmission according to a current serving grant value when the user equipment detects that the first channel does not carry the grant information.

14. The method according to claim 10, wherein controlling the data transmission comprises:
continuing performing, by the user equipment, the data transmission according to a current serving grant value when the user equipment detects that the first channel carries the grant information, wherein the grant information is a first grant instruction; and
stopping, by the user equipment, the data transmission when the user equipment detects that the first channel carries the grant information, wherein the grant information is a second grant instruction, wherein the first grant instruction instructs the user equipment to continue performing the data transmission according to the current serving grant value, and wherein the second grant instruction instructs the user equipment to stop performing the data transmission.

15. A user equipment comprising:
a receiver configured to receive a newly-added enhanced-absolute grant channel (E-AGCH) and a first channel that are sent by a network side device; and
a processor coupled to the receiver and configured to:
detect absolute grant (AG) information carried on the E-AGCH and grant information carried on the first channel; and
control data transmission of the user equipment according to a detection result.

16. The user equipment according to claim 15, wherein the processor is further configured to control the data transmission according to a detection result of the grant information carried on the first channel when it is detected that the E-AGCH carries a second AG information of another user equipment except the user equipment.

17. The user equipment according to claim 16, wherein when the processor detects that the E-AGCH carries the second AG information of the other user equipment except the user equipment, the processor is further configured to:
obtain an updated serving grant according to the grant information and a current serving grant value when it is detected that the first channel carries the grant information;
control the data transmission according to the updated serving grant value when it is detected that the first channel carries the grant information; and
stop the data transmission when it is detected that the first channel does not carry the grant information, wherein the grant information instructs to increase or decrease the current serving grant value.

18. The user equipment according to claim 16, wherein when the processor detects that the E-AGCH carries the second AG information of the other user equipment except the user equipment, the processor is further configured to:
control the data transmission according to the grant information when it is detected that the first channel carries the grant information; and
stop the data transmission when it is detected that the first channel does not carry the grant information, wherein the grant information instructs to continue performing the transmission according to a current serving grant value of the user equipment.

19. The user equipment according to claim 16, wherein when the processor detects that the E-AGCH carries the second AG information of the other user equipment except the user equipment, the processor is further configured to:
stop the data transmission when it is detected that the first channel carries the grant information, wherein the grant information instructs to stop the data transmission; and
continue performing the data transmission according to a current serving grant value when it is detected that the first channel does not carry the grant information.

20. The user equipment according to claim 16, wherein when the processor detects that the E-AGCH carries the second AG information of the other user equipment except the user equipment, the processor is further configured to:
continue performing the data transmission according to a current serving grant value when it is detected that the first channel carries the grant information, wherein the grant information is a first grant instruction; and
stop the data transmission when it is detected that the first channel carries the grant information, wherein the grant information is a second grant instruction, wherein the first grant instruction is used to instruct to continue performing the data transmission according to the current serving grant value, and wherein the second grant instruction is used to instruct to stop performing the data transmission.

21. A method for transmitting an absolute grant (AG) value, the method comprising:
receiving, by a user equipment, configuration information, sent by a network side device, of an enhanced-absolute grant channel (E-AGCH), wherein the configuration information comprises channelization code information and attribute information of the E-AGCH, and wherein the attribute information represents whether the E-AGCH is a conventional E-AGCH or a newly-added E-AGCH;
detecting, by the user equipment according to the channelization code information, AG information carried on the E-AGCH; and
controlling data transmission of the user equipment according to a detection result and the attribute information.

22. The method according to claim 21, wherein controlling the data transmission comprises:
updating a current serving grant using the AG information when the attribute information indicates that the E-AGCH is the conventional E-AGCH, and when the user equipment detects the AG information on the E-AGCH;
performing the data transmission according to an updated serving grant value when the attribute information indicates that the E-AGCH is the conventional E-AGCH, and when the user equipment detects the AG information on the E-AGCH; and
continuing performing the data transmission according to the current serving grant value when the attribute information indicates that the E-AGCH is the conventional E-AGCH, and when the user equipment does not detect the AG information on the E-AGCH.

23. The method according to claim 21, wherein controlling the data transmission comprises:
updating a current serving grant value using the AG information when the attribute information indicates that the E-AGCH is the newly-added E-AGCH, and when the user equipment detects the AG information of the user equipment on the E-AGCH;
performing the data transmission according to an updated serving grant value when the attribute information indicates that the E-AGCH is the newly-added E-AGCH, and when the user equipment detects the AG information of the user equipment on the E-AGCH;
stopping the data transmission when the attribute information indicates that the E-AGCH is the newly-added E-AGCH, and when the user equipment detects AG information of another user equipment except the user equipment on the E-AGCH; and
continuing performing the data transmission according to the current serving grant value when the attribute information indicates that the E-AGCH is the newly-added E-AGCH, and when the user equipment does not detect the AG information on the E-AGCH.

24. The method according to claim 21, further comprising:
receiving, by the user equipment, an instruction order sent by the network side device; and
changing the attribute information of the E-AGCH according to the instruction order, wherein the instruction order is used to instruct the user equipment to change the attribute information.
